(19) United States
(12) Patent Application Publication
(10) Pub. No.: US 2014/0039648 A1
(43) Pub. Date: Feb. 6, 2014

(54) SYSTEM FOR INSPECTION AND MAINTENANCE OF A PLANT OR OTHER FACILITY

(71) Applicant: Saudi Arabian Oil Company, Dhahran (SA)

(72) Inventors: David BOULT, Dhahran (SA); Ayedh S. AL-SALEH, Dammam (SA)

(73) Assignee: Saudi Arabian Oil Company, Dhahran (SA)

(21) Appl. No.: 13/955,883

(22) Filed: Jul. 31, 2013

Related U.S. Application Data
(60) Provisional application No. 61/678,410, filed on Aug. 1, 2012.

(51) Int. Cl. G05B 15/02

(52) U.S. Cl. CPC G05B 15/02
USPC 700/79

(57) ABSTRACT

The present invention is a computerized inspection and maintenance system for an industrial plant or other facility. The system comprises a plurality of software modules which are both interactive with inspectors, maintenance, and supervisory personnel and interact with one another

### CROSS-REFERENCE TO RELATED APPLICATIONS

The present application claims priority on U.S. provisional patent application No. 61/678,410, filed on Aug. 1, 2012.

### BACKGROUND OF THE INVENTION

Large industrial companies, for example in the oil and gas industries, often operate many geographically separated plants (such as refineries) and other facilities (such as pipelines) whose equipment needs to periodically inspected and maintained. Plants and other facilities may be spread out across large geographic regions.

In the oil and gas industries, companies typically adopt standard inspection schedules, pursuant to which each piece of equipment is subject to inspection and/or testing at specified times. In the case of the oil and gas industries, equipment scheduled for inspection and maintenance includes piping, nipples, motors, pumps, and other mechanical and electrical equipment. Oil pipelines, in addition to periodic inspections of the piping and joints, typically have a robust pipeline protection system (referred to herein as a “high integrity protection system”) between the wellhead and the pipeline. The high integrity protection system prevents spikes in oil pressure, which may exceed the pipeline's pressure rating, from reaching the pipeline piping itself. Such system needs to be periodically tested and, if required, serviced to ensure that it is properly functioning.

In practice, the inspection practices, record keeping, and maintenance/repair procedures carried out at different plants and facilities may differ from one another, leading to inefficiencies and added costs. Inspection and maintenance systems present a number of additional challenges, some of which include:
Accurately determining, storing, and providing timely notification of the next-scheduled inspection dates for numerous pieces of equipment at each plant or facility;
Scheduling plant times, organizing personnel for, and tracking of inspections of numerous pieces of equipment;
Ensuring that inspectors follow prescribed and updated inspection and reporting procedures;
Efficiently organizing and tracking of maintenance when required for particular pieces of equipment;
Ensuring maintenance personnel follow prescribed and updated maintenance and reporting procedures;
Providing and periodically updating company-wide uniform compliance standards and communicating such standards in an effective manner to personnel spread over many plants or other facilities;
Efficiently collecting and collating plant data for key performance indicators; and
Generating timely reports for supervisory and management personnel.

The scheduling and implementation of periodic inspections and record keeping typically is centralized within each plant or other facility. This can lead to a lack of uniformity in the standards, procedures, record keeping, and reporting throughout the company. It thus is difficult to maintain uniformity and efficient reporting and coordination in large companies due to the large numbers of equipment types used, each of which has its own inspection schedules and protocols as well as maintenance protocols.

Inspectors and maintenance engineers often have learned to improve inspection and maintenance techniques, e.g., to spot more effectively potential problems while inspecting equipment, or to implement more efficient repair and maintenance procedures, from their past experience on the job. Conventional inspection and maintenance systems do not provide an effective mechanism for capturing such experience, and thus such information is utilized only by a limited number of engineers or inspectors. Thus, the utilization of lessons learned tends to be restricted to use, if at all, to a single plant.

### SUMMARY OF THE INVENTION

The present invention is a computerized inspection and maintenance system. The system comprises a plurality of software modules which are both interactive with inspectors and maintenance personnel and which interact with one another, to provide an improved, more versatile, more accurate, system. The invention further provides uniformity in inspection and maintenance procedures, and in the reporting, processing, and record keeping of such procedures.

Each module is programmed to perform a specific, discrete function in connection with an overall inspection and maintenance plan, such as to schedule periodic inspections of all equipment, supervise the administration of an inspection program for each piece of equipment, or to implement and track maintenance required for a specific piece of equipment.

One module performs the function of calculating and storing future inspection dates based upon stored criteria related to the applicable type of equipment, and of automatically initiating a communication on or near to such dates to appropriate personnel to initiate the inspection process. During inspections and maintenance work, inspectors and maintenance engineers receive notifications from the system, and may access specific maintenance and inspection modules both to obtain information from the module as to the particular inspection/maintenance to be performed, and also for generating reports to be collected, stored, and processed by the system.

For example, when an inspector determines that maintenance is required and enters such information into the system, the system automatically sends notification to appropriate maintenance personnel, who can then access the system as part of the maintenance procedure. A module of the system generates an electronic Worksheet which is used by the maintenance engineer to carry out the needed work and report. Such modules may provide, upon request, information concerning specified repair or replacement protocols.

The system includes a Security Module which ensures that appropriate supervisor approvals are obtained prior to and during inspection work and maintenance work. Using the Security Module, the system provides for a standardized workflow procedure which obtains the necessary reviews and approvals for all inspection work and maintenance performed. More particularly, when pre-authorization is required to perform certain inspection or maintenance procedure, or when sign-off approval is required at the completion of a step, the system sends notification, e.g., by e-mail or text message, to the appropriate supervisory personnel. Such authorized person must log onto the system and enter the necessary authorization or approval as appropriate before the inspection/maintenance procedure can continue.

The Inspection Schedule Module maintains a schedule for the next inspection of each piece of equipment. After inspection and maintenance, if required, such Module determines and stores the next inspection date, which determination may be based on any maintenance work performed during the last inspection, or based on other information entered into the system by the inspector.

Thus, the present invention is a corporate inspection and management system which reduces the costs of operating and maintaining a corporate plant, such as a manufacturing facility, refinery, or pipeline. The system provides flexibility and optimizes work processes. It permits proponent required enhancements which can be deployed more easily than in conventional inspection and management systems. The system integrates inspection management with plant maintenance initiation, tracking, record keeping, and reporting.

The system maintains central equipment master data storage which serves for both inspecting and maintaining equipment to eliminate duplication and inconsistent data, and provides access to a full history of pieces of equipment and other plant systems.

The system further provides sophisticated and flexible security and authorization functionality. The scheduling and monitoring of all inspection processes are automated. The system automatically generate inspection forms and data-collection sheets. Such forms may be generated on remote data devices, such as laptop computers or tablet devices, along with inspection specifications and procedures. The forms may thus be filled in by the inspector or maintenance engineer and remotely and electronically transmitted to the central computer operating the system.

The system provides automatic analysis of inspection results and determines subsequent actions and/or decisions required.

The system provides one central application to be used for all inspections. It will provide a single approach to calculating values such as minimum thickness (T-min) used on certain inspection processes, such as when using corrosion coupons, and other inspection formulae. The system allows all of the information to be stored in a single location and protected using the company's disaster recovery policies.

The system defines inspection work processes having a defined examination program plan for organizing, scheduling, and tracking all inspection work at the company's facility either as delineated by the company or by an individual ad hoc compliance requirement.

The system provides systematic work processes for many inspection activities associated with the monitoring of the condition of equipment. The system provides systematic tracking for high integrity protection systems used with pipelines. The system provides a unique approach to pipeline inspection work processes. Inspection of the pipelines is performed by an instrument scraper and the vast amount of data is pre-processed by the system to specific rules such that worksheets or work orders are automatically created and the work is tracked to completion.

The system provides a synergetic integration among Inspection, Plant Maintenance, Project Management, Operations, and Human Resources departments. For example, when an operator (inspector or maintenance engineer) needs to perform an inspection or maintenance work, the system may send an inquiry to the Human Resources department to check and enter into the system the certifications and levels of education of the operator to confirm that the operator is authorized and certified to perform a certain function. In particular, the system streamlines cross-department workflows and at the same time provides the required sophisticated security and authorization procedures as well as complex escalation procedures. Escalation uses the Human Resources department hierarch at predefined intervals to expose non-compliance.

The system further eliminates duplication of work and inconsistent data both within a department and across multiple departments. The system provides unique audit/assessment tracking and methodology which enhances proactive operations.

The system generates and makes available to authorized personnel key performance indicators. This function is performed in the Business Warehouse using Dashboards and signals. It also facilitates joint operations between departments by defining and tracking the various responsibilities of such departments.

The system generates and provides to responsible personnel standard reports and “smart forms” (digital representations of a form which can be completed on any modern communications equipment providing an intrinsically safe form). Standard reports have a common format and uniform terminology to be shared by all users from all departments.

When a problem is reported, the system automatically identifies equipment with similar potential problems due to similarities between equipment or operating conditions. It further facilitates a cross-department root cause drill down analysis for incidents, and provides a sophisticated process for capturing and searching of lessons learned.

The system ensures full compliance with company standards, procedures, and requirements through centralized tracking. It supports risk-based inspection implementation and asset performance management, by closely adhering to the input requirements for such procedures. The system may also be used to ensure customer and employee satisfaction by distributing surveys and feedback.

Thus, the system supports central planning for all plants by providing central master data and efficient communications and notifications. Finally, the system can provide estimates of man-hours and costs of various inspection, maintenance, and repair processes to support enterprise resource planning procedures and budget estimates.

The basic processes which form the inspection portion of the system for use in the oil industry include the following process modules:

| Module | Description | Details |
|---|---|---|
| Equipment | A master equipment table | The table also includes static data, such as |
| | lists all equipment which | operating temperatures and pressures, |
| | needs periodic inspection | manufacturing details, and documentation such |
| | | as a safety instruction sheet and equipment |
| | | inspection schedule, and data sheets |
| On-Stream | Stores UT (ultrasonic | Displays and manages drawings; stores |
| Inspection | thicknesses); contains | inspection results and calculates and displays |
| | software for analyzing | information on corrosion rates and remaining |
| | results and predicting safe | life. Requires modification to include data |
| | working limits for each | point scheduling (i.e., to handle different types |
| | applicable piece of | of data points called condition monitoring |
| | equipment | location as well as the existing function) |
| Equipment | For each specific piece of | Includes inspection logs and records which are |
| Inspection | equipment, stores the results | stored in a database management system |
| Historical | of past inspections | |
| Records | | |
| High Integrity | Detailed tracking and | The testing and installation of this equipment |
| Protection | testing data with stringent | has been formulized in several standards and |
| System | escalation routines | procedures. These procedures call for close |
| Tracking | | tracking and communication between |
| | | scheduled maintenance |
| Leak Reports | Specifies information to be | In the case of the oil industry, this will include |
| | gathered on equipment | pipelines as well as pressure vessels and |
| | which has developed a leak | refinery equipment |
| Hydrostatic Test | Specifies and stores results | Includes simple recorded storing routines and |
| Reports | of pressure testing of | storing of schedules of when revalidation is |
| | equipment for integrity. | required. |
| | This includes new | |
| | equipment as well as | |
| | equipment being recertified | |
| Inspection | Inspector's tickler file for | Used to schedule next inspections in order to |
| Schedule | each piece of equipment | transmit notices, e.g., by e-mail, to applicable |
| | which requires periodic | inspection personnel |
| | inspection | |
| Worksheets | A document management | A complex (meaning it has many functions and |
| | and workflow system for | many interactions with personnel and systems, |
| | reporting defects to the | i.e., SAP PM) module of word processing |
| | proponent | documents and the movement around a |
| | | workflow diagram |
| Non-Destructive | Specifies and records results | Includes all methods of non-destructive testing |
| Tests | of various types of non- | |
| | destructive tests and tracks | |
| | status of operator | |
| | certifications for each piece | |
| | of equipment on which such | |
| | tests are performed | |
| Inspection of | Specifies the work process, | The results may be displayed using a complex |
| Landing Base | and records the results, for | module of word processing documents and the |
| (i.e., the area | inspection of well landing | movement around a workflow diagram |
| surrounding a | bases for an oil, gas, or | |
| wellhead) | water well | |
| Technical Alerts | Documentary proof of | A document management system of alerts and |
| | compliance with the | storage (i.e., a technical alert has an action and |
| | company's technical alerts | this is storage against such alerts) |
| | system; a technical alert is | |
| | issued when a fault in a | |
| | component has a wide- | |
| | ranging effect on most of | |
| | the corporate facilities, e.g., | |
| | counterfeit components | |
| Tools | Contains information and | Includes software for an inspector to calculate |
| | procedures to assist | T-min based on national standards, software |
| | inspectors with calculations | generating a conversion calculator, and |
| | | software to generate a non-destructive testing |
| | | calculator |
| Cathodic | Specify and record | This is mainly a producing requirement (i.e., |
| Protection | inspection results for | most of this equipment is used in the oil and |
| | cathodic protection | gas-producing facilities), but is core to all |
| | inspections (electro- | plants |
| | chemical processes that | |
| | reduce corrosion on | |
| | equipment through a | |
| | sacrificial process) | |
| Corrosion | Corrosion coupons are used | Requires detailed analysis to discover the |
| Coupon | to measure the rate of wear | extent of field usage, i.e., the rate at which the |
| monitoring | of equipment such as | equipment is corroding |
| | pipelines; coupons are | |
| | periodically removed and | |
| | thickness is measured to | |
| | determine rate of wear | |
| Electrical | Specifies and records results | Simple recorded storing routines with |
| Condition | of inspections carried out on | scheduling for the next re-validation of |
| Monitoring | electrical equipment | equipment |
| Civil Condition | Specifies and records results | Simple recoded storing routines with some |
| Monitoring | of inspections on pieces of | scheduling for re-validation of equipment at |
| | civil equipment (concrete | pre-defined time intervals. |
| | structures and fireproofing) | |

In general, for periodic inspections, the Inspection System module determines, either from pre-entered data or by calculation using a specified formula, the next-scheduled inspection and/or maintenance procedure (such as end-of-life replacement of a part) for each piece of equipment. The computer system, which includes a clock, monitors the Inspection System module for upcoming scheduled dates. At a predetermine time prior to the scheduled inspection/maintenance procedure, the computer system generates an alert, which may be in the form of an e-mail message to one or more applicable inspection personnel.

Such message may first be routed to one or more supervisors, who must approve the proposed work, and then forwarded to the actual inspector(s). Alternatively, a supervisor may return such message, or otherwise communicate approval to the computer, at which point the computer will record the approval and generate a new message to the inspector(s).

During the course of inspection work, the inspector has access to the applicable inspection modules, and can download procedures, data, and tools for performing the inspection work. As inspections are performed, the inspector records the results, preferably on electronic forms, e.g., on the inspector's computer/table screen. Such data, along with the inspector's final sign-off, is transmitted to the computer and recorded in the applicable module.

In cases where the inspector determines that maintenance work is required, and enters such information into the system, the system automatically notifies appropriate maintenance personnel. Maintenance engineers may then access the system (after the system requests and obtains the necessary supervisory approvals, it needed), where a module generates a Worksheet to specify and track the needed repairs or parts replacement. The maintenance modules ensure that appropriate authorizations are obtained at various stages of the maintenance procedures.

Certain Maintenance Modules are decision based, and require various inputs from maintenance engineers during maintenance procedures. Such inputs determine further process steps. In certain cases, a Maintenance Module may hand off control of the maintenance process to a different Module for processing of a particular type of condition. Thus, at least some of the Modules are interactive with one another.

### BRIEF DESCRIPTION OF THE DRAWINGS

FIG. 1 is a schematic drawing of the system according to the invention;

FIG. 2 is flow diagram to illustrate the operation of an Equipment Master data service module;

FIG. 3 is flow diagram to illustrate the operation of a Lesson Learned module;

FIG. 4 is flow diagram to illustrate the operation of Security and Authorization module;

FIG. 5 is flow diagram to illustrate the operation of a Corrosion Coupon module;

FIG. 6 is flow diagram to illustrate the operation of a Leak Incident module;

FIG. 7 is flow diagram to illustrate the operation of an On Stream Inspection module;

FIG. 8 is flow diagram to illustrate the operation of an Inspection Log module;

FIG. 9 is flow diagram to illustrate the operation of a Cathodic Protection module;

FIG. 10 is flow diagram to illustrate the operation of a Hydrostatic Test module;

FIG. 11 is flow diagram to illustrate the operation of a Plant Assessment module;

FIG. 12 is flow diagram to illustrate the operation of a Landing Base module;

FIG. 13 is flow diagram to illustrate the operation of an Inspection Survey module;

FIG. 14 is flow diagram to illustrate the operation of a Detailed Repair Scope module;

FIG. 15 is flow diagram to illustrate the operation of a Non-Destructive Test module;

FIG. 16 is flow diagram to illustrate the operation of a Worksheet module;

FIG. 17 is flow diagram to illustrate the operation of an Equipment Inspection Schedule module;

FIG. 18 is flow diagram to illustrate the operation of a Maintenance Tracking System module;

FIG. 19 is flow diagram to illustrate the operation of Sleeve Installation module;

FIG. 20 is flow diagram to illustrate the operation of an Equipment Reconditioning module;

FIG. 21 is flow diagram to illustrate the operation of an Instrument Scraping module;

FIG. 22 is flow diagram to illustrate the operation of a Document Management module;

FIG. 23 is flow diagram to illustrate the operation of a Testing and Inspection Packaging and Scheduling module; and

FIG. 24a-24c are flow diagrams to illustrate the operation of a High Integrity Protection System module.

### DETAILED DESCRIPTION OF EMBODIMENTS OF THE INVENTION

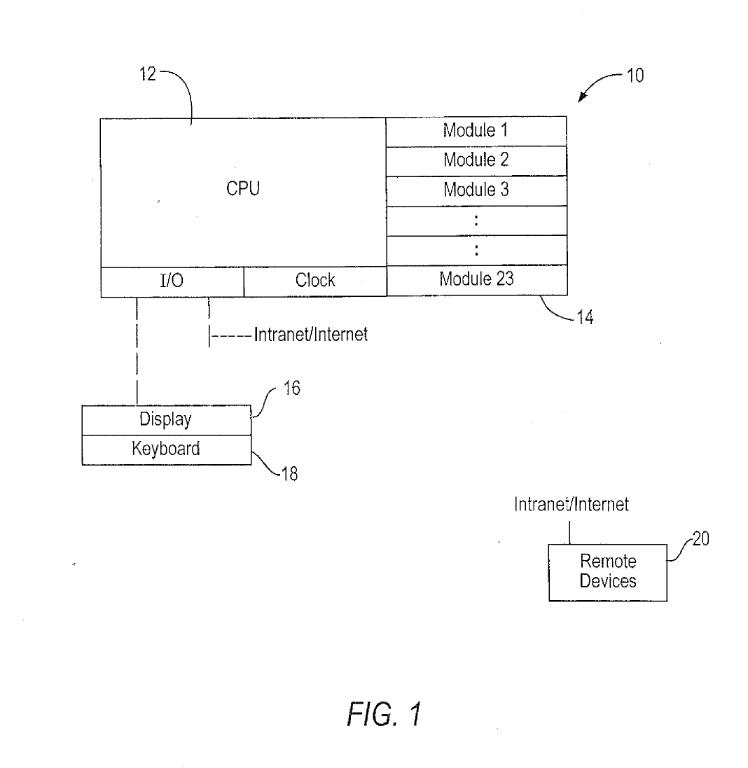

FIG. 1 schematically illustrates the system for inspection, repair and maintenance of the equipment in a plant according to the invention. The system operates with a main computer 10 having a CPU 12, input output equipment I/O, and a plurality of inspection, repair, and maintenance modules 14 which may be selectively accessed by the CPU 12.

A display 16 and keyboard 18, for use by an operator, are connected to the input/output I/O. The input/output I/O also provides a connection to a company intranet or the internet. Preferably, a plurality of remote computer devices 20 may be connected to the computer 10 by any suitable means, such as over the company's intranet, over the internet, or over a wireless connection. The remove devices 20 may be other computers, laptops or the like, tablet devices, smart phones, or any other device which can at least receive, and preferably receive and transmit, information.

The system, through the use of the various modules 14, examples of which are described below, provides integration of various plant functions including inspection, planned maintenance, project management, and operational and human resource departments in the plant. The system provides data centralization, communications and notification functions, sophisticated security and authorization control, and integrated work processes. The system also provides uniformity in optimized inspection, installation, and maintenance functions.

All master data for equipment and operational activities are centralized on the computer data base. Real time data collection, analysis, and processing are available for the management of all departments for in-time decision making. Centralized master data provides full asset history, elimination of duplicate work, elimination of inconsistent data, and facilitation of the implementation for asset performance management and risk based inspection. This makes use of the corporate master data to record all inspection activities to allow a full history, both financial and physical, to be available for most of the modern asset management techniques. In the past, inspection activities and data had its own domain of reference which caused confusion and duplication. The present invention solves such shortcoming.

A unified reporting system generates easy to understand standard reports by all users of all departments. Moreover, standardized work processes use standard escalation procedures (centralized and standardized escalation process if work in not completed in a timely manner which is auditable), workflows, automated notification, and auto-formation of emergency teams.

Activation of a module requires predetermined authorizations, which are grouped by business roles. Authorization keys are assigned to master data objects and inspection activities, to ensure that repair, inspection, and maintenance procedures are authorized before being carried out. Such keys also ensure that data entered into the system only by authorized personnel. The security/authorization system ensures separation of duties and responsibilities. It can also identify the responsible person for any erroneous or unauthorized operation.

The system provides lean plant operations because it ensures compliance with the plant standards, procedures, and requirements. It allows such standards, procedures, and requirements to be updated and revised easily, at any time. Also, it includes, and can communicate to plant personnel, “lessons learned” and “best practices.” It further provides a single, coherent equipment history to provide unique features relevant to the particular inspection being performed.

In accordance with the invention, the work processes are tailored to provide a total approach to all inspection activities associate with condition monitoring in large industrial facilities.

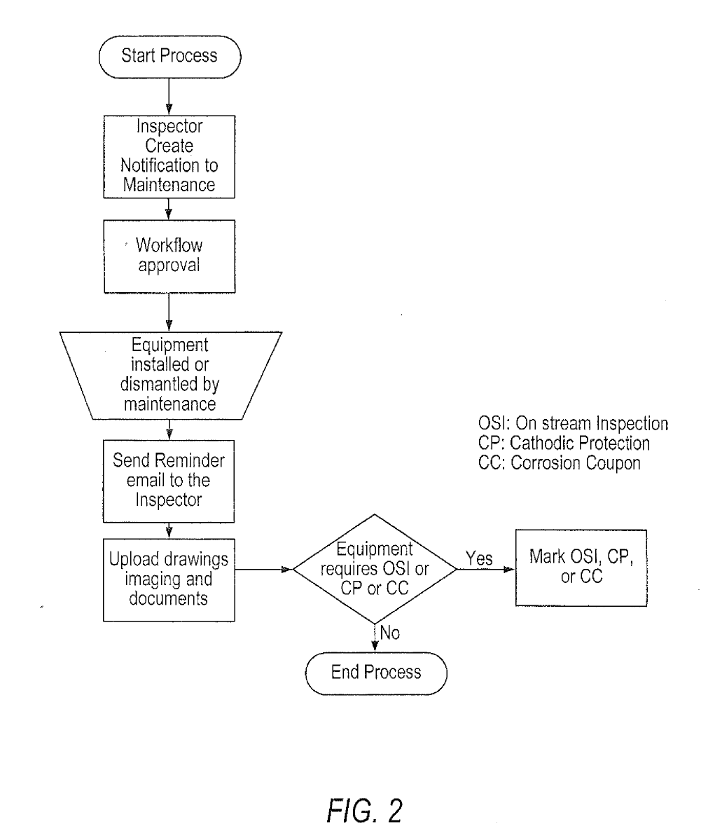

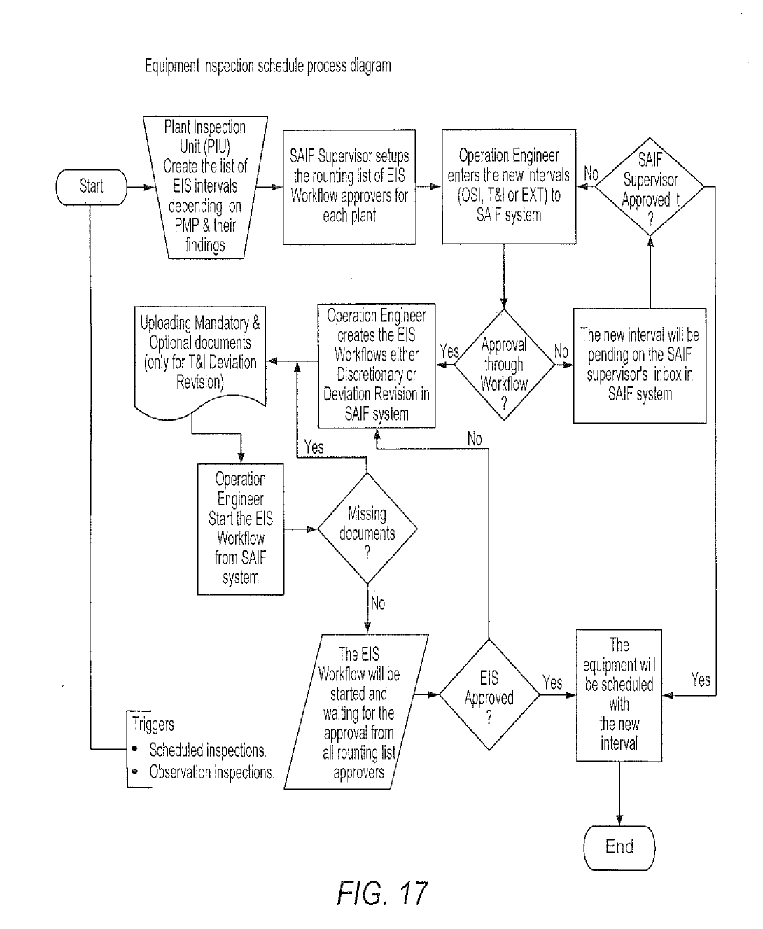

FIG. 2 is a flow chart of the Master Data software module. For each piece of equipment, the computer monitors the date for next inspection or maintenance procedure. In the event that routine inspection is required, or in response to an input that equipment has failed or is malfunctioning, the computer sends a notice, e.g., by e-mail, to inspection personnel, who performs the necessary inspection. If no maintenance or repair work is required on the inspected equipment, the inspector enters appropriate inspection information into the computer system, which then generates and logs the next date of inspection. Depending on the inspection activity, the determination of the next-scheduled date may be determined in the Equipment Inspection Schedule Module, FIG. 17 (for T&I, it is logged in the EIS; for OSI, it is calculated).

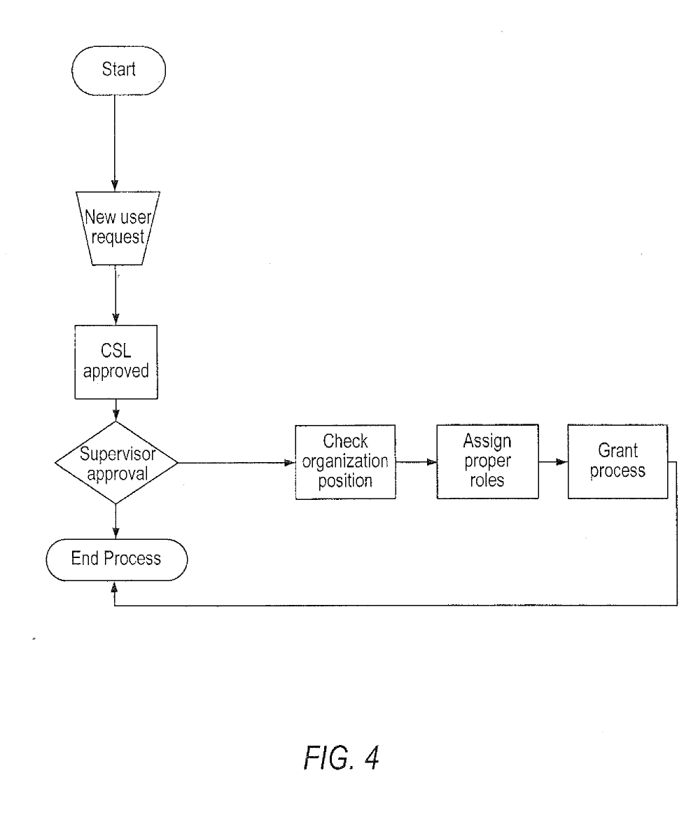

Alternatively, if the inspector determines that repair or replacement is required, the inspector makes an appropriate entry into the computer 10, which generates a notification to maintenance personnel detailing the required maintenance or inspection required. Such notice is also sent to appropriate supervisor for approval, as described in connection with FIG. 4 below.

Upon approval by the supervisor, maintenance personnel will replace the subject equipment, or dismantle the corresponding equipment for repairs. Upon completion, maintenance personnel will enter an appropriate report into the computer, which will then notify inspection personnel, who will then perform the appropriate re-inspection. As part of inspections and repairs, the maintenance personnel and inspectors may upload drawings, imaging, or other documents as required.

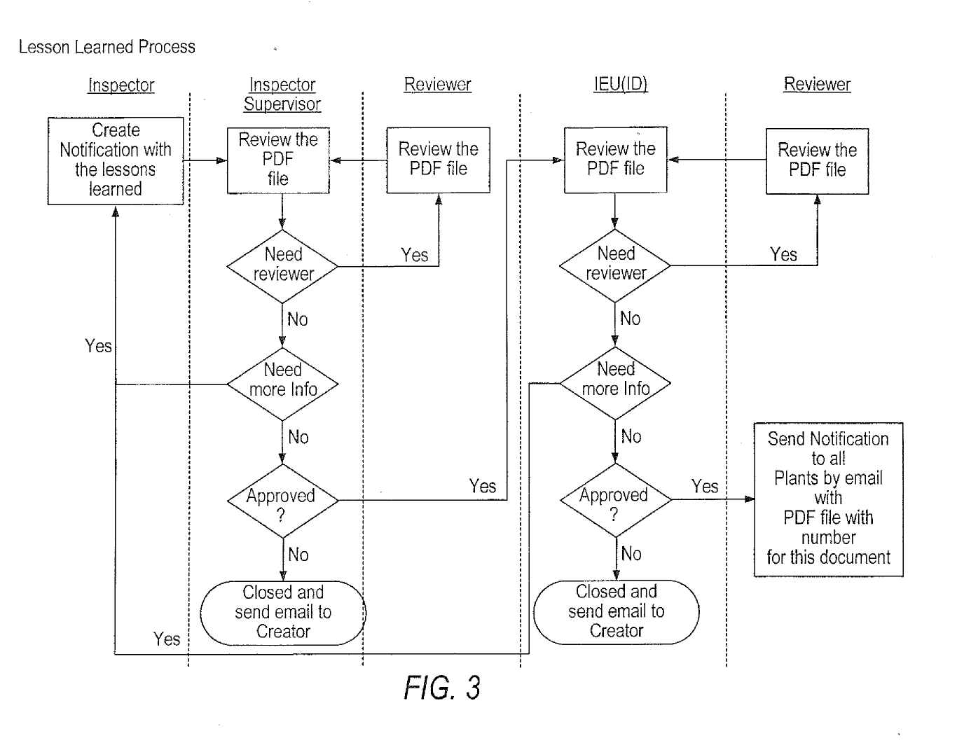

FIG. 3 is a flow chart of a Lesson Learned software module. Such module may be accessed by an inspector or other authorized user to document and publish lessons learned regarding the performance or maintenance a particular piece of equipment. For example, after inspectors analyze an incident and discover a gap in implementing procedures, or after maintenance personnel discover from experience an improvement in a maintenance or repair procedure, such inspectors can log onto the system to create a notification entry which is stored in the computer and may be accessed during future inspections, maintenance, and repairs.

In the example of FIG. 3, after a notification entry has been created and stored in the computer, the computer sends a notification to the inspector's supervisor, who after logging onto the system is prompted to review the entry and make the initial determination whether the entry needs to be reviewed further by a different reviewer (a person with an expertise different from the supervisor's expertise). If the entry is to be reviewed by a reviewer who is not the supervisor, the supervisor enters the identity of the reviewer and logs off. The system then sends an e-mail notification to the reviewer, who logs onto the system, reviews the entry, determines whether the entry needs further information and makes a recommendation whether to approve the entry, and then logs off. The system then sends an e-mail notification to the supervisor indicating the receipt of the review.

The supervisor, either initially or after review by the reviewer, determines whether the entry requires further information and enters such determination electronically. If so, notification is sent to the inspector to provide such further information. After such additional information is entered, the system notifies the supervisor, the supervisor logs on, and the supervisor/reviewer review process is conducted again.

Once the supervisor determines that the entry is complete, the supervisor makes a determination whether the entry should be approved, and enters such decision electronically. If the entry is not approved, the system sends an e-mail notification to the inspector and the entry is not made available as part of the Lessons Learned data base. If the entry is approved, it may be subject to further review and scrutiny before being made available on the Lessons Learned data base. Such additional review is optional, and may be used for certain types of inspections but not others.

In the example of FIG. 3, after being approved by the inspector's supervisor, the system sends a notification by e-mail to the inspection engineering unit, whose personnel logs onto the system and initially determines whether the entry needs review by a different reviewer. If no, or if review has been completed by such different reviewer, inspection engineering determines whether more information is required and whether the entry is approved, essentially repeating the process of the inspector's review.

Once an entry has been reviewed and finally approved, the system sends a notification to all plants by e-mail with an attached PDF file “with the number for this document.” While the system does display the Lesson Learned, the e-mail is a way of highlighting the problem to plants.

FIG. 4 is a flow chart which shows the process for security and authorization. Preferably, system authorization should be role-based rather than user-based (authorization is accepted based on the user's position rather than based on his or her name). Preferably, whenever an employee is assigned to a particular position, his or her profile is assigned specified authorization roles automatically. Alternately, the system allows the manual assignment of authorizations to employees.

The security and authorization module is run as part of the log on process for the system. When a user requests to log onto the system, such user provides security information such as a user name and password. A sub-module checks the organizational position of the user and assigns corresponding authorization to gain access to information or to issue approvals.

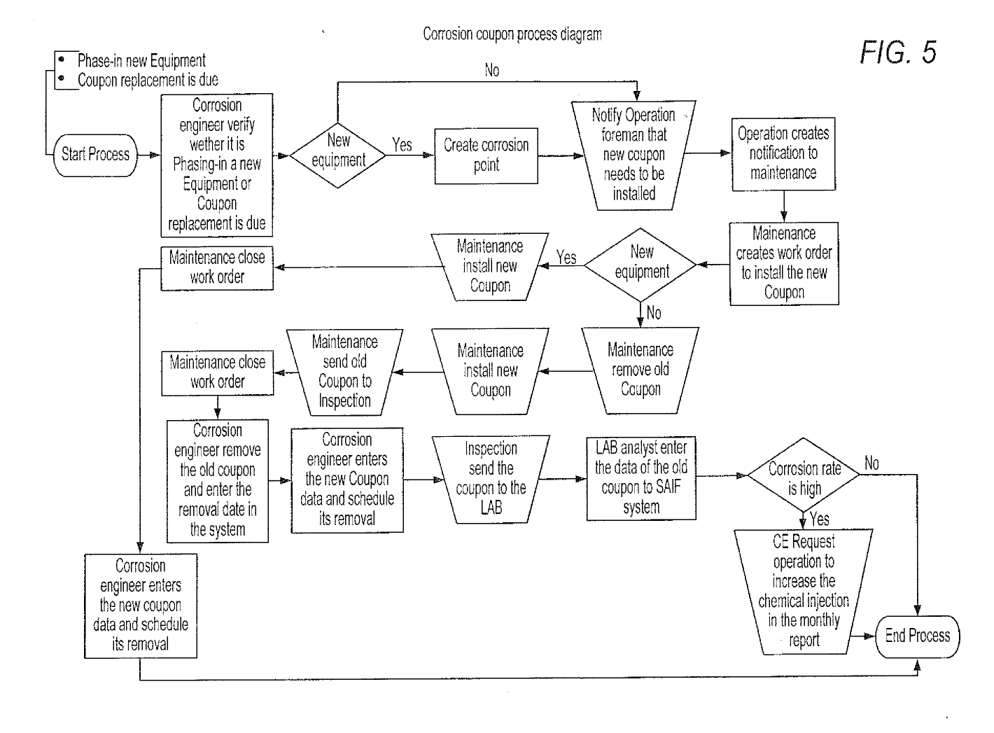

FIG. 5 is a flow diagram for a corrosion coupon testing. A corrosion coupon is a small strip of metal that is placed inside piping and plant vessels. The coupon is weighed and then installed inside a pipe or vessel at a coupon point. After a predefined period of time, monitored by the Equipment Master Data module, the system sends a notification by e-mail to maintenance personnel. Responsive to such notification, such personnel remove the old coupon and replace it with a new coupon. The used coupon, after being removed, is sent to a laboratory and weighed. The loss in weight, divided by the period time inside the pipe, determines the corrosion rate. The metal loss analysis is sent for approval by a senior chemist, and then entered into the system to determine when the piping needs to be replaced. Thus, the system calculates the mils per year, which is the corrosion rate of the asset.

Referring to FIG. 5, a new corrosion coupon installation is performed when new equipment is installed and after receiving notification that the corrosion coupon in an existing piece of equipment needs to be replaced. When a corrosion coupon needs to be installed or replaced, a corrosion engineer notifies an appropriate person, such as a foreman, that a coupon needs to be installed. If the installation is for new equipment, a corrosion engineer first creates a coupon point for installing the coupon before notifying the foreman. The corrosion engineer then logs onto the system with an entry indicating that a coupon needs to be installed. In response to such entry, the system sends a notification to maintenance to create a work order to install a new coupon.

Appropriate maintenance personnel determine whether the installation is to be performed in new versus existing equipment. If the former, the installation is performed and the work order is closed. The corrosion engineer then logs onto the system and enters data regarding the installation and schedules the required removal date. The removal date is monitored by the Equipment Master Date module, and a notification for coupon removal is sent at the appropriate time.

In the case of existing equipment, prior to installing a new coupon, maintenance personnel first remove the old coupon and forward the used coupon for laboratory inspection prior to closing the work order. When the corrosion engineer logs onto the system such person, in addition to entering information concerning the new coupon, enters the removal date of the old coupon into the system.

As further indicated on FIG. 5, when a used coupon is received by the laboratory, the results are entered into the system. If the Corrosion Process Module determines that the corrosion rate is higher than a predetermined threshold (set initially by corrosion engineers), the system sends a notification to appropriate operations personnel to increase chemical injection, which may also be included in the monthly report.

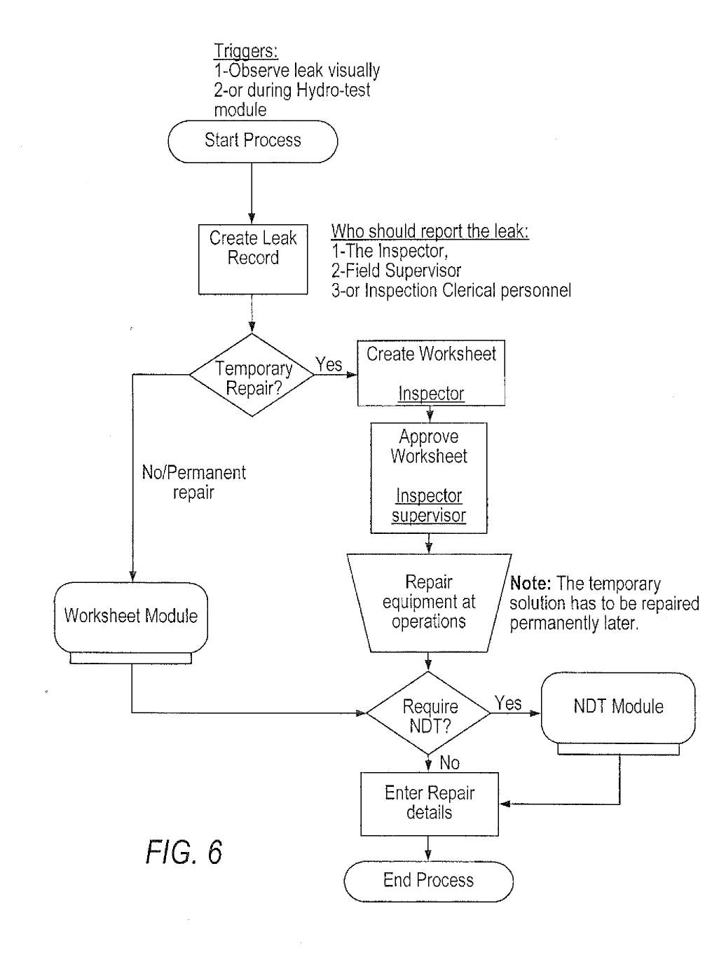

FIG. 6 is a flow diagram of the Leak Incident Module, which is used to report and detail any leaks which occur in equipment along with repair details. It is also used in connection with routine leak inspections which test the condition of specific equipment internally or externally. Routine inspection of leaks is performed in order to predict any leakage and maintain affected equipment proactively. In the case of routine inspections, notification is sent by e-mail automatically at the appropriate time by the Equipment Master Data Module.

As shown in FIG. 6, in the event of a leak, the inspector logs onto the system and, after activating the Leak Incident Module, inputs a command to create a Leak Record. The Module queries the inspector as to whether the repair to be made is temporary or permanent. If temporary, the system creates a worksheet, in which appropriate data is entered by the inspector. The system sends a notification to the inspector's supervisor, who must log on and approve the temporary repair, which is then made.

If the repair to be made is permanent, a worksheet module creates a worksheet in which similar information is entered into the system, and the repair is made.

As shown in FIG. 6, in either case, after the worksheet has been entered into the system, the inspector determines from experience whether the equipment requires non-destructive testing. If no, the information on the Worksheet is entered into the system. In addition, if the repair is temporary, an inspection log is created which remains open until the repairs are complete.

If testing is needed, a Non-Destructive Testing Module creates a testing worksheet and supplies to the inspector the testing routine and conditions. If the test is successful, the Worksheets are then entered into the system.

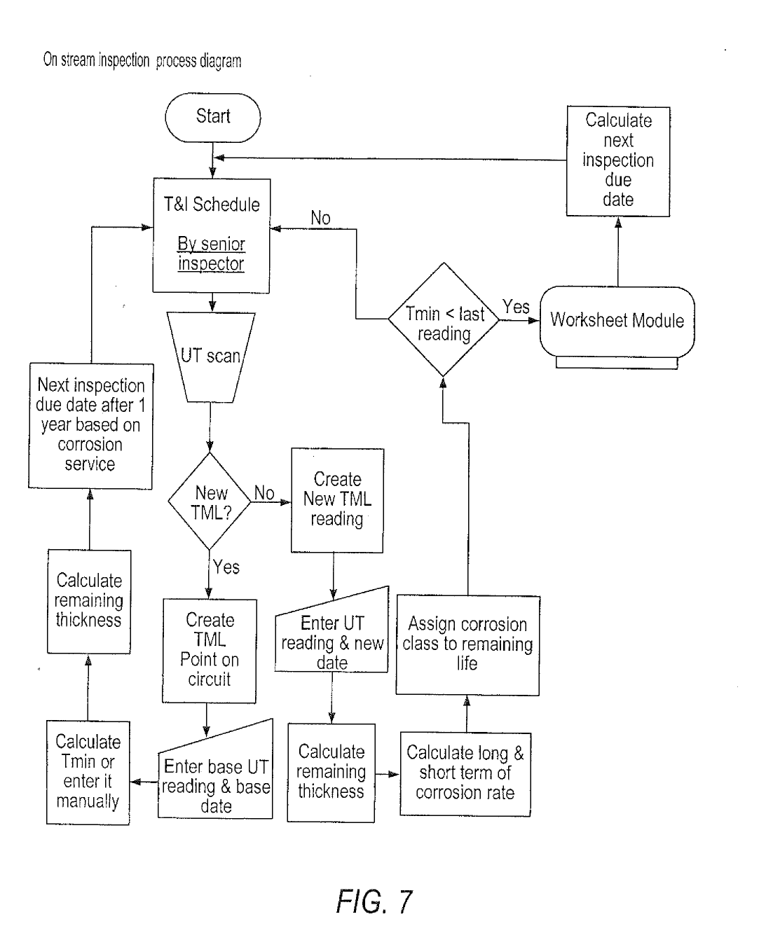

FIG. 7 is a flow diagram for an On Stream Inspection Module. On stream inspection is used to monitor the internal condition for equipment and calculates its remaining life. It measures the minimum thickness at specific points on the equipment. The results are registered in System Assurance and Inspection of Facilities in the appropriate module and used to calculate the minimum thickness corrosion rate, remaining life, and when next readings should be taken. The next reading is scheduled through the system in the OSI module to notify inspectors of the next upcoming inspection.

As shown in FIG. 7, at a date determined by the test and inspection schedule, an inspector runs an ultrasonic thickness scan. The inspector logs onto the system and launches the On Stream module and enters whether a new thickness measurement location is needed. If yes, the Inspector creates a TML point on a circuit (a baseline thickness is entered, at various points on the equipment, onto the system). The inspector enters the base UT reading and the date of testing. Thereafter, either the system calculates the minimum required thickness, or such value(s) are entered manually. The system also calculates the remaining allowable thickness loss before the equipment needs to be replaced. Finally, the system schedules a next inspection date, which may be one year later, depending on the corrosion class as defined by SAEP-1135 and SAEP-20, table 2.

If the equipment is not new, the Inspector creates a new TML reading. The inspector then enters the UT reading and date of testing. The system then calculates the remaining allowable thickness loss, the long and short term rates of corrosion, and assigns a corrosion class to the remaining life which depends on whether corrosion rate is high versus low.

Next, the system determines whether the measured thickness is less than the last reading. If yes, the system generates a worksheet module. The inspector enters relevant information and the system calculates the next inspection date accordingly. If the measure wall thicknesses have not decreased, the next inspection date is entered as a predetermine time period, such as one year.

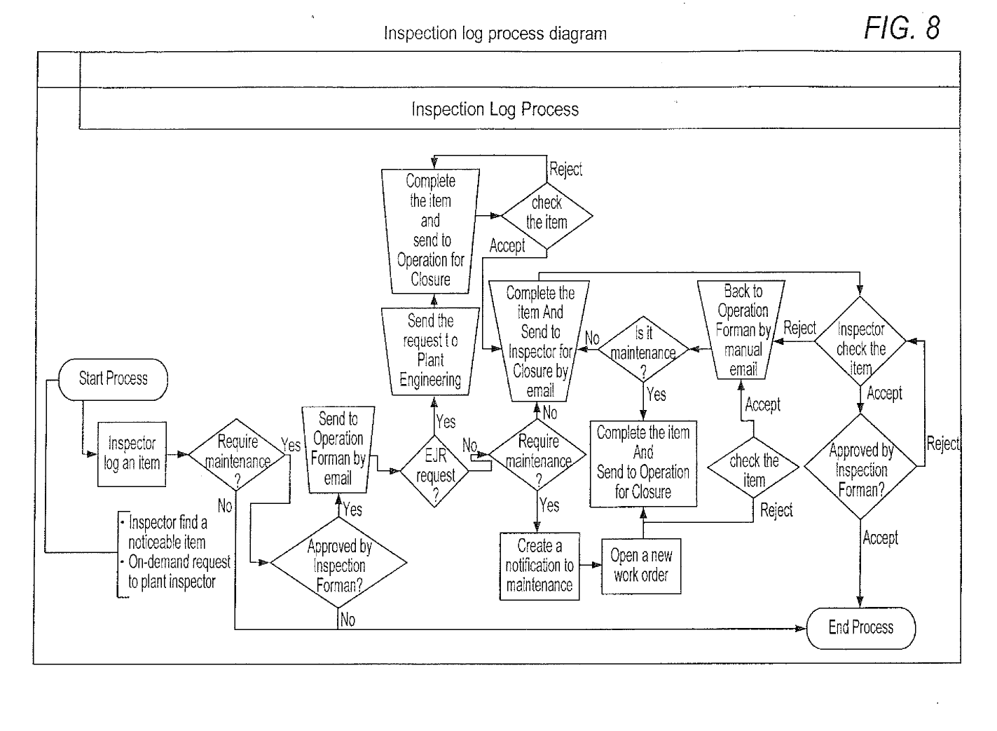

FIG. 8 is a flow diagram for an Inspection Log Module. An inspection log is used to record and manage routine plant inspection surveys or on-demand inspection requests. There are two types of inspection logs: (1) defect findings which requires plant operations involvement to resolve the defect; and (2) normal notification (non-defect) findings that do not require repair work to be done.

As set out in FIG. 8, when an inspector is notified of an equipment problem, he or she logs onto the system and launches the Inspection Log Module. The inspector logs the item and enters whether any remedial action is required. If yes, the module requests confirmation that the action has been approved, e.g., by the inspection foreman. If approved, an e-mail is sent to the operation foreman indicating what action is required.

The operation foreman, after logging onto the system, enters whether the request is an Engineering Job Request. If no, the system prompts the foreman to indicate whether the request requires action by maintenance personnel. If yes, the system creates and sends a notification to maintenance. Maintenance creates on the system a new work order, physically completes the item, and the system sends notice to operations for closure. Operations personnel then check the item, and indicate on the system whether the item is accepted or rejected. The system may interactively thereafter perform several addition checks, e.g., ask the operations foreman determine whether the job requires remedial work to be performed by Maintenance (if so, notification is sent to the PM group). Thereafter, notification of the completed item is sent to an inspector, who determines whether to accept the work.

In the case of a non-EJR request that does not need the involvement of maintenance, the request is completed and notification is sent to the inspector as above.

If the request is an EJR request, the system sends notification to the Plant Engineering department, who completes the item. After entering into the system an indication that the item is complete, notification is sent to the inspector as above.

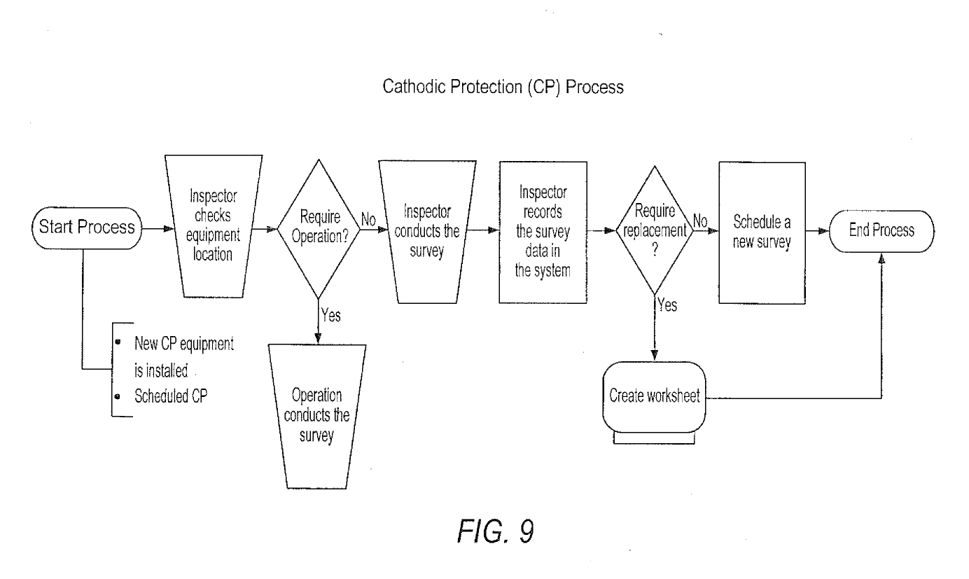

FIG. 9 is a flow diagram of the Cathodic Protection Module. Cathodic protection is a system which protects and prevents corrosion in equipment by using electrical or sacrificial sources that supply the equipment with enough electrons to change the corrosive properties of the equipment. In the present invention, the system collects information about the cathodic protection system at regular intervals. Collected data is used to evaluate and adjust the protective system.

Referring to FIG. 9, the cathodic protection module is run when new equipment is installed and for scheduled inspections. In a first, off-line step, the inspector determines whether the inspection will require operations personnel. If yes, such personnel conduct the test, and enter the results into the system. If not, the inspector conducts the survey and enters the survey data into the system. The Inspector determines whether replacement is required.

If replacement is not required, the Inspector schedules the next survey date. If replacement is required, the system generates a worksheet which is used to document and record the replacement process.

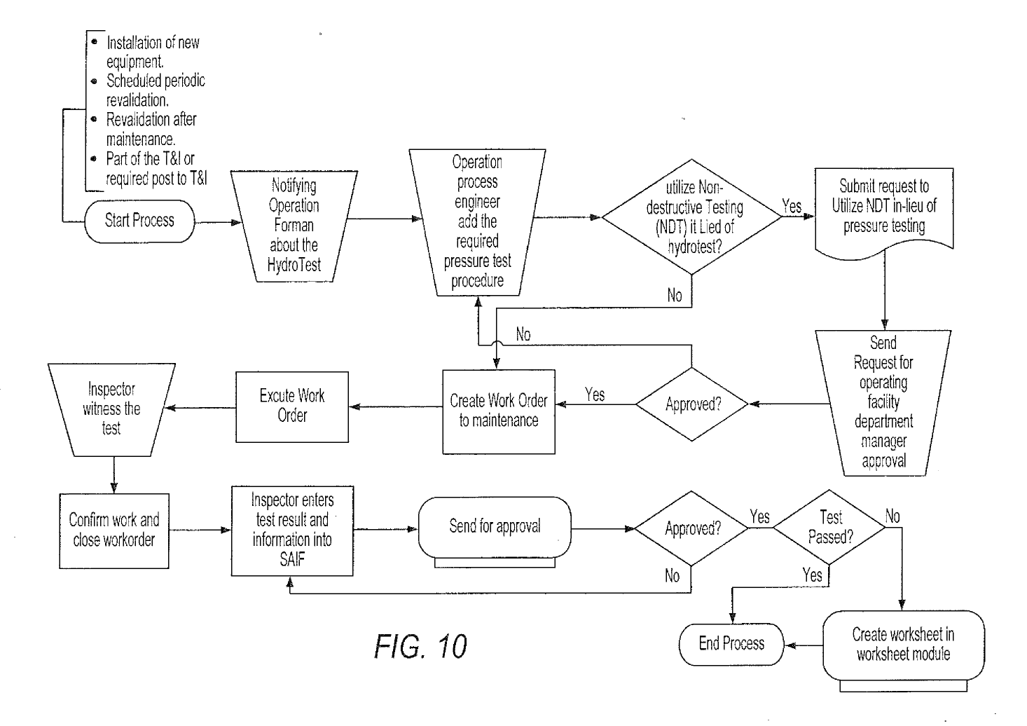

FIG. 10 is a flow diagram of a Hydrostatic Test Module. Hydrostatic testing is a pressure test conducted on piping or equipment subject to internal liquid or gas pressure to ensure it meets certain strength and tightness requirements for a predetermined period of time. The current system permits inspectors to store test results and schedule the next revalidation test.

As indicated in FIG. 10, the Hydrostatic Test Module is run when new equipment is installed, when scheduled revalidation testing is performed, after maintenance has been performed, after testing and inspection has been performed, or after a plant shutdown.

The inspector first notifies the plant foreman that hydrostatic testing is scheduled. An operation/process engineer supplies the required pressure test protocol. Either the inspector or engineer determines whether non-destructive testing may be used in place of a hydrostatic test. If yes, the system automatically generates and sends notification to request approval to use non-destructive testing in place of hydrostatic tests. If approved, the system creates a work order and sends it to the maintenance department. If not approved, hydrostatic testing is carried out.

If hydrostatic testing is to be used, the system creates a work order and sends notice to the maintenance department, which carries out the test with the inspector present. If successful, the inspector enters relevant information into the system and closes the work order. The system then forwards the test result to an appropriate supervisor for approval. If the report is approved, the system enters the results if successful, and creates a worksheet if the equipment failed the tests.

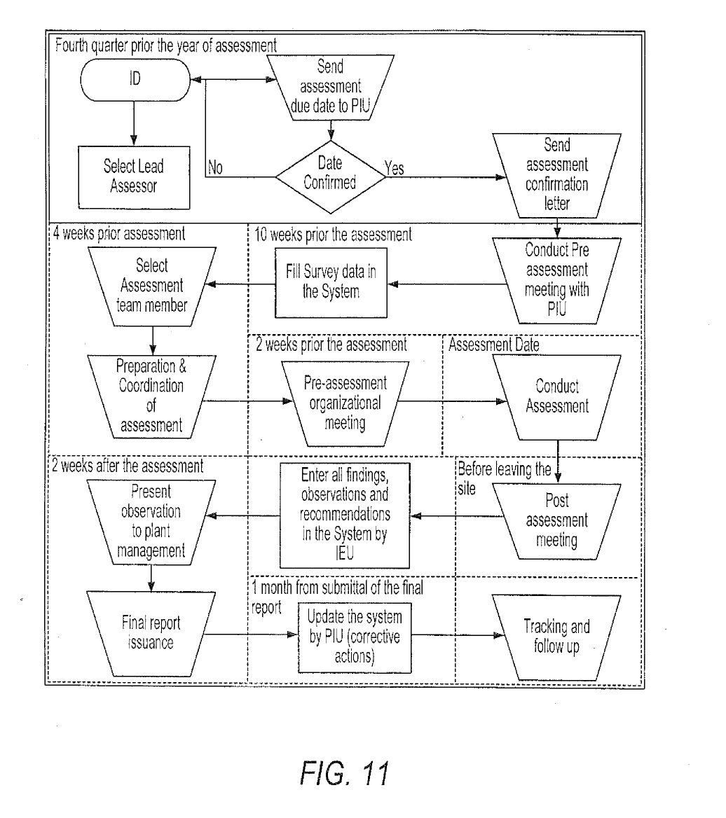

FIG. 11 is a flow diagram of a Plant Assessment Module. Plant assessment is a periodic event (typically carried out every 3-4 years) to assess the performance of inspection programs within all facilities. This is a joint process operation between the inspection department and the plant inspection unit to assess and store findings, observations, and recommendations for modifying procedures. The plant inspection unit normally will take corrective actions within a predetermined time.

As shown in FIG. 11, prior to and during plant assessment, various preparatory procedures take place off line. All findings, observations, and recommendations are entered into the system. If approved, the system monitors the implementation of the recommendations and follows up with notifications as required.

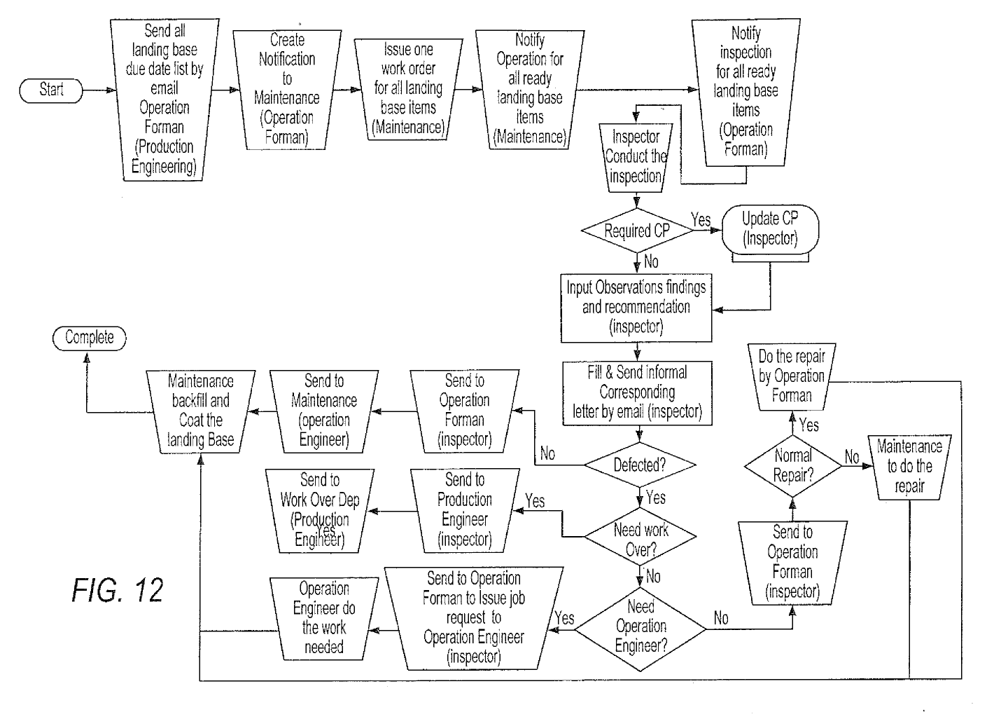

FIG. 12 is a flow diagram of a Landing Base Module. Landing base refers to area around an oil/water well that delivers the oil to plants. Inspection of landing bases is performed periodically, e.g., every seven years for oil wells and every four years for water wells. The inspections are performed mainly as visual and ultrasonic inspections. The results of the surveys are reported to selected persons according to the inspector's requirements.

As shown on FIG. 12, after an inspection the findings and recommendations are input into the system. The system determines whether the findings indicate that the site is defective. If the site is clean, the system sends the report to the Operation Foreman and Maintenance. If the site needs work, the Inspector determines whether the site needs work over and, if so, generates and sends the necessary work requests. If the Inspector determines that work over is not needed, but that an operational engineer is needed, the system generates and sends the appropriate requests for implementation.

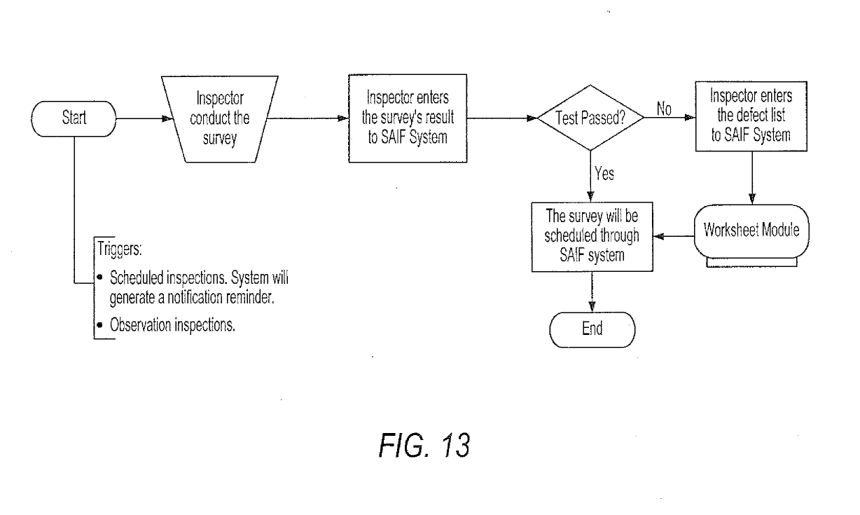

FIG. 13 is an Inspection Survey Module. This module records, manages, and schedules all civil and electrical inspection survey types. The module also creates a worksheet if defective equipment is found during an inspection.

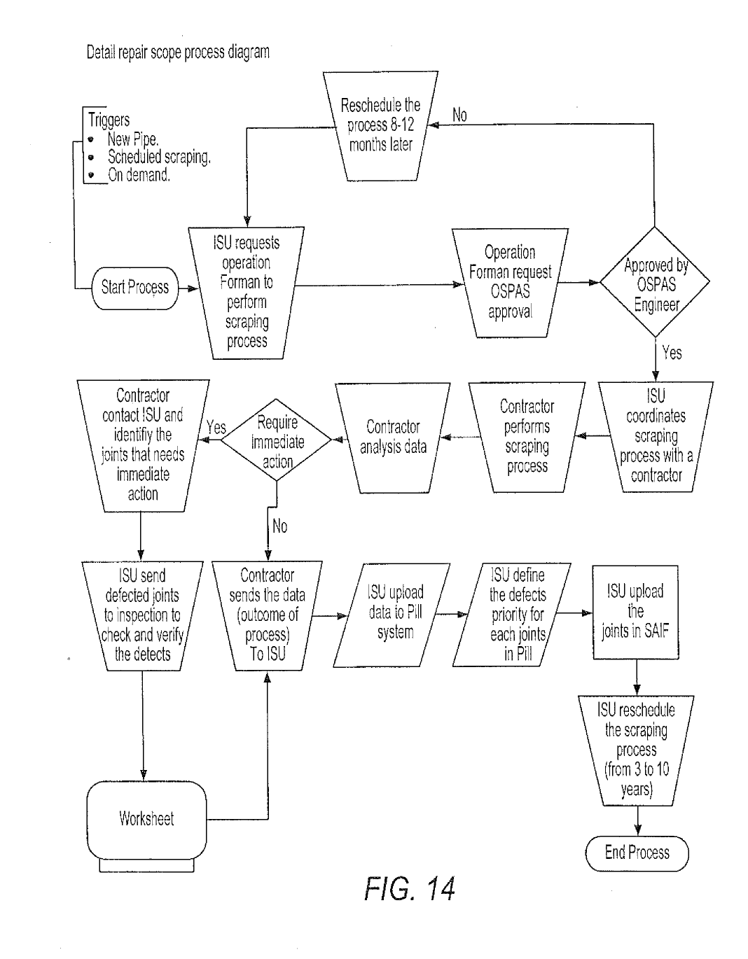

FIG. 14 is a Detailed Repair Scope Module. Detailed repair scope is a list of all defected scrapable segment joints for a particular maintenance repair plan that is retrieved from a pipeline in-line system. The defective joints are rectified in scheduled periods.

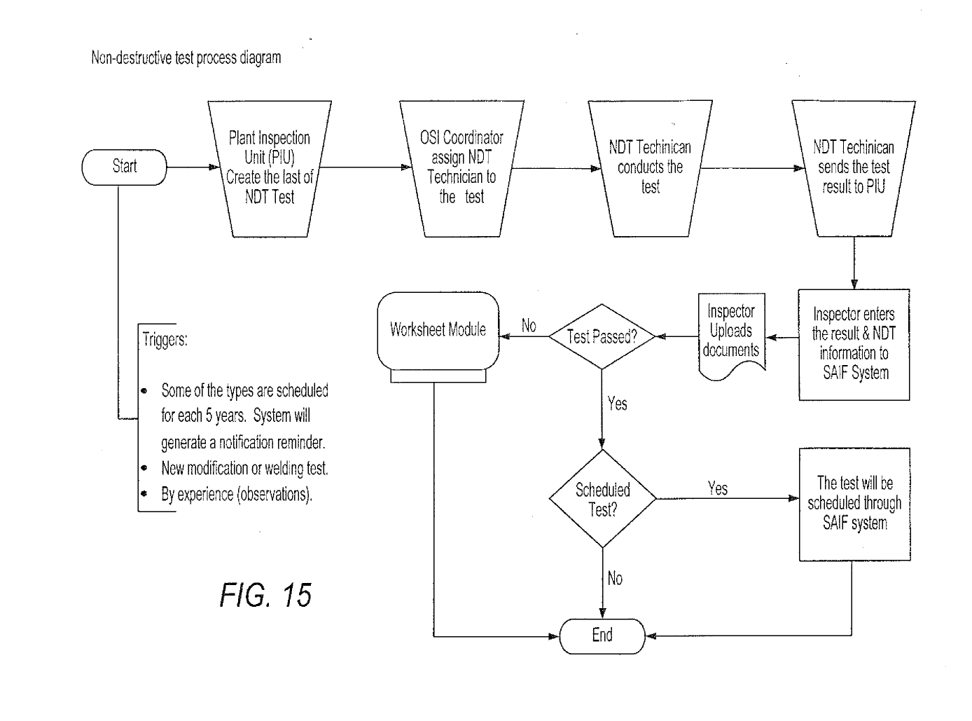

FIG. 15 is a flow diagram for a Non-Destructive Test Module. Non-destructive testing is a process of examining the integrity of equipment using various non-invasive techniques such as X-ray, ultrasound, or magnetism. Such techniques can reveal imperfections in the material or component. Referring to FIG. 15, non-destructive testing can be initiated in several ways. The Equipment Master Data module maintains an inspection schedule for equipment requiring periodic non-destructive testing. When an inspection is due, the system sends a notification to the plant inspection unit. Also, when equipment is modified during servicing, such as work that involves welding, non-destructive testing procedures are initiated. Such procedures may also be initiated as a result of observations by plant personnel.

The plant inspection unit creates and maintains a list of non-destructive tests, which are stored in the system. When non-destructive test procedure is to be performed, a testing coordinator assigns a technician who conducts the tests. The technician sends the test results to the plant inspection unit. An inspector at the plant inspection unit then logs onto the system and, after initiating the Non-Destructive Test Module, enters the results of the tests. If the equipment passes the test, the system determines whether the piece of equipment has a scheduled date for future testing. If it does not, the system determines the next test date and stores and monitors such date in the Equipment Master Data module.

If the equipment does not pass the test, the system creates a worksheet in the Worksheet Module and initiates a servicing process to confirm that appropriate repair or replacements are made.

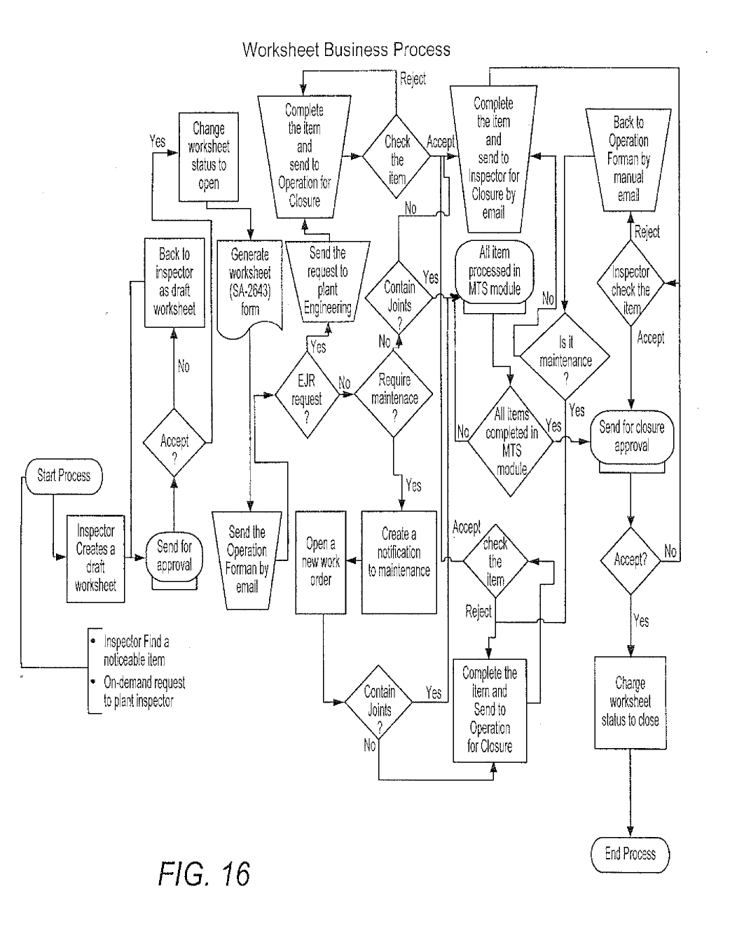

FIG. 16 is a flow diagram of a Worksheet Module. The Worksheet Module is used when deficiencies occur that require involvement by plant operation and maintenance personnel.

As indicated in FIG. 16, the Worksheet Module is used when an inspector finds a noticeable item or there is an on-demand request to plant inspection for service. The inspector logs onto the system and initiates the Worksheet Module, which makes available on-screen a Worksheet. The inspector enters appropriate information and sends the Worksheet to a supervisor for approval. The system notifies the appropriate supervisor that a Worksheet has been created which needs review and approval. The supervisor then logs onto the system and retrieves the draft Worksheet. If the supervisor rejects the Worksheet, the supervisor may enter the reasons. The system then sends notification to the inspector that the Worksheet has been rejected. The inspector may then log onto the system, retrieve and correct the Worksheet, which is again made available to the supervisor for review.

Once the Worksheet has been approved, the Worksheet Module changes the Worksheet status to “open,” and generates (if not already in plant usable form) an appropriate form. The system sends an e-mail to an operation foreman to advise that the system has an open Worksheet.

The operation foreman, after logging onto the system, enters whether the request is an Engineering Job Request. If no, the system prompts the foreman to indicate whether the request requires action by maintenance personnel. If yes, the system creates and sends a notification to maintenance. Maintenance creates on the system a new work order.

The system prompts the foreman to indicate whether the equipment to be serviced contains joints. If yes, then the work order is processed in the Maintenance Tracking System (MTS) module. If no, the work process continues in the Worksheet Module. The foreman physically completes the item, and the system sends notice to operations for closure. Operations personnel then check the item, and enter into the system an indication whether the item is accepted or rejected. If accepted, notification of the completed item is sent to an inspector, who determines whether to accept the work. If accepted, the inspector will send the Worksheet to a closure module for closure. If the Worksheet is rejected by the inspector, he enters such rejection into the Worksheet Module, which then sends notice back to the Operations foreman to repeat the process.

In the case of a non-EJR request that does not need the involvement of maintenance, the Operations foreman is prompted to enter whether the equipment contains joints. If yes, the Worksheet is processed using the MTS Module. If no, the Worksheet is sent to the inspector for review, approval, and closure as described above.

If the request is an EJR request, the system sends notification to the Plant Engineering department, who completes the item. After entering into the system an indication that the item is complete, a supervisor in Plant Engineering reviews the Worksheet and, if approved, notification is sent to the inspector as above.

FIG. 17 is a workflow diagram of an Equipment Inspection Schedule Module. Such Module is used to automate the documentation of inspection intervals and inspection procedures of initial and subsequent tests and inspections for equipment within all company facilities.

As indicated in FIG. 17, personnel from the Plant Inspection Unit create a list of routine inspection intervals, based on accepted industrial norms, and their findings, e.g., recommendations from the equipment manufacturer. Such information, along with a routing list for workflow approvals for each plant, are entered into the Equipment Inspection Module by an Operations Engineer. The system then notifies the members of the routing list of the scheduled inspection intervals and requests approval. If not approved, notification will be sent to a supervisor. The supervisor logs onto the system and, in the Equipment Inspection Module, either agrees with the non-approval, and sends the schedule back to Operations, or overrides the non-approval, in which case the system schedules the equipment for inspection accordingly.

Once members on the routing list approve the proposed maintenance schedule, an Operations Engineer creates and enters into the system workflows, either discretionary with the plant management (within defined limits) or deviation revision (i.e., which require central engineering approval. Such Engineer also uploads mandatory and optional documents for testing and inspection deviation revision (changes to the shutdown dates).

Once such information has been uploaded, the engineer from the Operations Department starts a workflow subroutine and determines whether there are any missing documents. If no, notification is sent to the reviewers on the routing list requesting they review and approve the workflow. Once approved, the equipment will be scheduled with the new intervals.

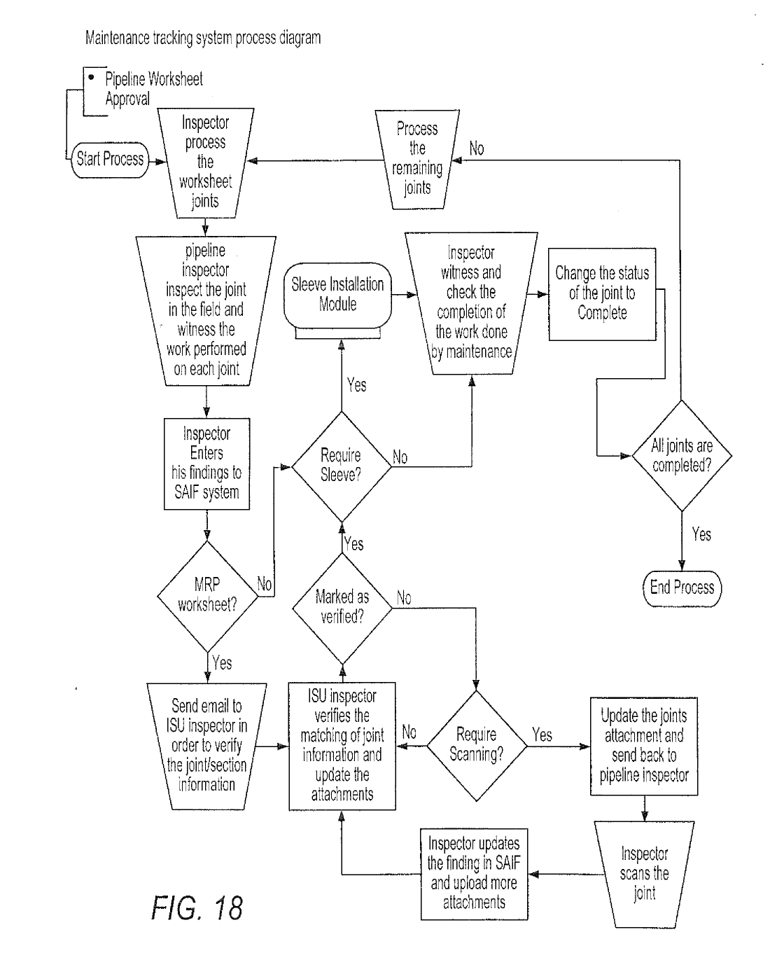

FIG. 18 is a flow diagram of a Maintenance Tracking System Module (MTS) (which is referred to in connection with FIG. 16). Maintenance tracking is used to track each defected (having a discontinuity in the asset) pipeline joint reported by an approved inspection worksheet. The joint is tracked by a Pipeline Inspection Unit and Instrument Scraping Unit. The integrity of all joints in an inspected section of pipeline need to be verified and completed prior to closing the inspection Worksheet.

As indicated in FIG. 18, in carrying out an inspection process, if the inspection involves pipeline, a field inspector is assigned to carry out the joint inspections as part of the Worksheet. After inspecting the joints, the inspector enters the inspection findings into the system using the MTS Module. The system prompts the inspector to indicate whether maintenance is a needed (whether the joints passed inspection). If yes, the system sends an e-mail to an inspector in an organization known as the Instrument Scraping Unit (ISU) to verify the joint/section information. The ISU inspector logs onto the system and, in the MTS Module, verifies the matching of joint information and updates the attachments. Thus, as work to remove the discontinuity progresses, a report of such progress is uploaded to the system. The system then prompts the ISU inspector to indicate whether the Worksheet confirms that the inspection is marked as verified. If no, the system prompts the inspector to indicate whether scanning of the joint is required. If yes, the system sends notification to the field inspector to perform scanning and update the Worksheet. If the answer to MRP worksheet” is “no,” no action is taken.

If the Worksheet is marked as verified, the ISU inspector is prompted to indicate whether a sleeve will be required for maintenance work. If yes, a sleeve is provided running a “Sleeve Installation Module,” described below. If no sleeve is needed, or after the sleeve has been installed, maintenance work is completed. The ISU inspector inspects the completed work and changes the status of the Worksheet to complete.

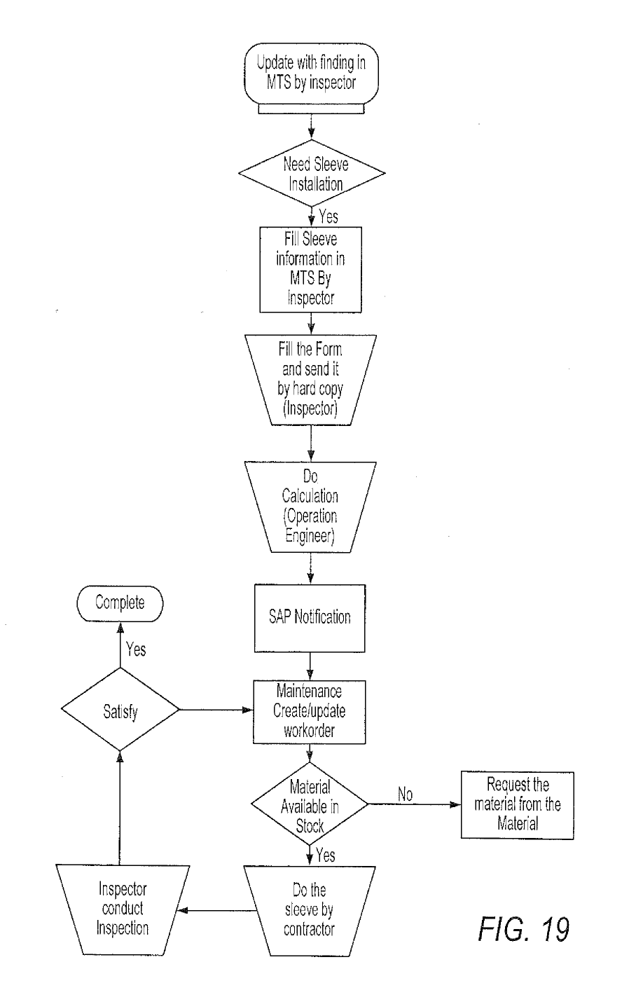

FIG. 19 is a flow diagram of a Sleeve Installation Module. Sleeve installation is a process of installing a material to prevent the pipeline from leaking or protecting the pipeline from corrosion that may cause a leak. Sleeve installation is done as part of the field inspector's findings during the Maintenance Tracking System inspections. Once the sleeve installation is completed, it is verified by an inspector.

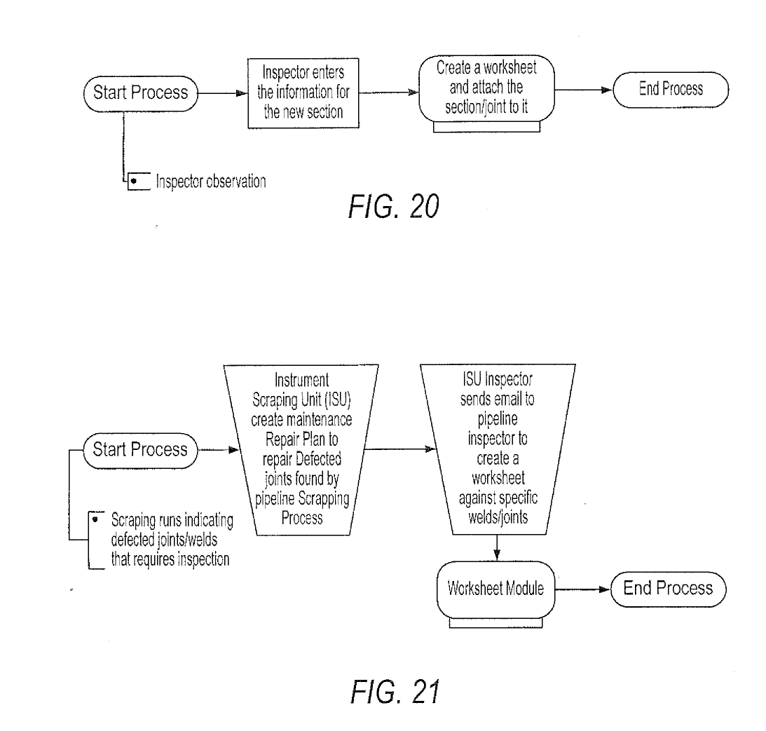

FIG. 20 is a flow diagram of an Equipment Reconditioning Module. Such Module is use to log a section of pipeline which has been inspected and which needs rehabilitation work. Essentially, the module, when activated, runs the Worksheet Module to specify that maintenance work is needed, and updates the system when the work has been completed, inspected, and approved.

FIG. 21 is a flow diagram of an Instrument Scraping Module. Pipeline scrapers are installed throughout a pipeline network. The scrapers are mainly used to ensure the integrity and reliability of the pipeline. A pipeline instrument test, performed using the scrapers, is normally conducted every five years as part of a maintenance repair plan. As indicated in FIG. 21, an Instrument Scraping Unit (ISU) creates the maintenance repair plan to repair defective joints found during the pipeline scraping process. The plan is uploaded to the system. Either the system or the ISU inspector sends an e-mail to a pipeline field inspector, to create a Worksheet using the Worksheet module.

The scheduling for performing the maintenance repair plan inspections may be maintained and monitored in the Equipment Master Data Module, which sends out notification to the Instrument Scraping unit at the appropriate time.

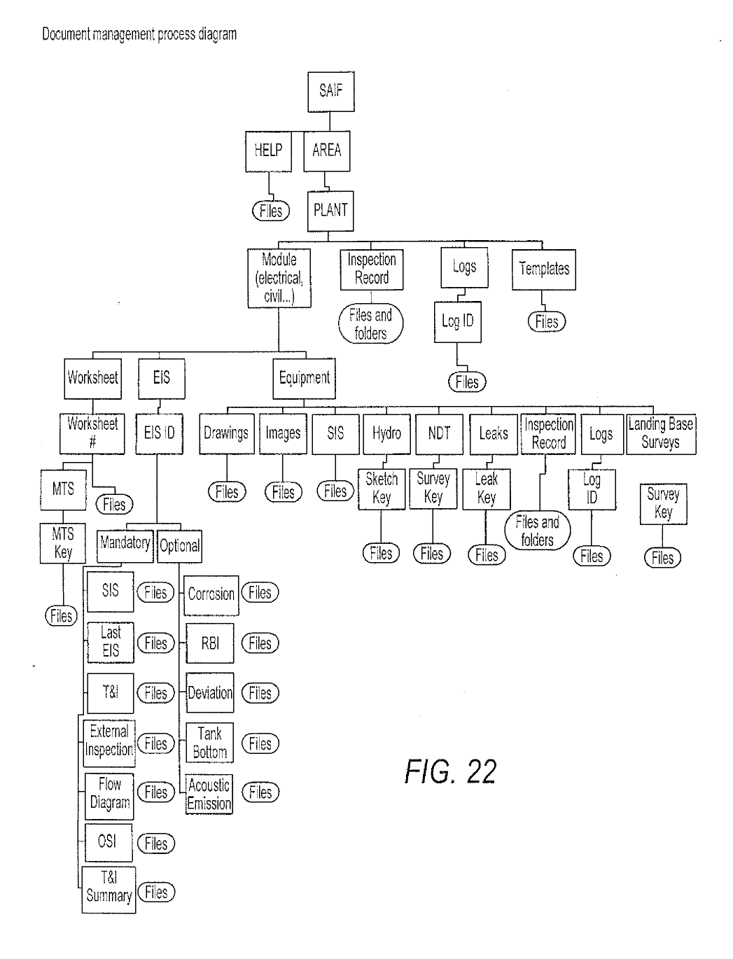

FIG. 22 is a flow diagram of a Document Management Module. The Management system centrally manages and maintains inspection attachments. In addition, such system, is responsible for linking such attachments to SAP objects to eliminate duplicate uploads. The system provides an improved way to classify attachment documents and provides improved searching capability. The system allows inspectors to check-in (file) and check-out attachments and easily modify them from SAP. Furthermore, the system provides a sophisticated way to manage the versioning and approval of the documents.

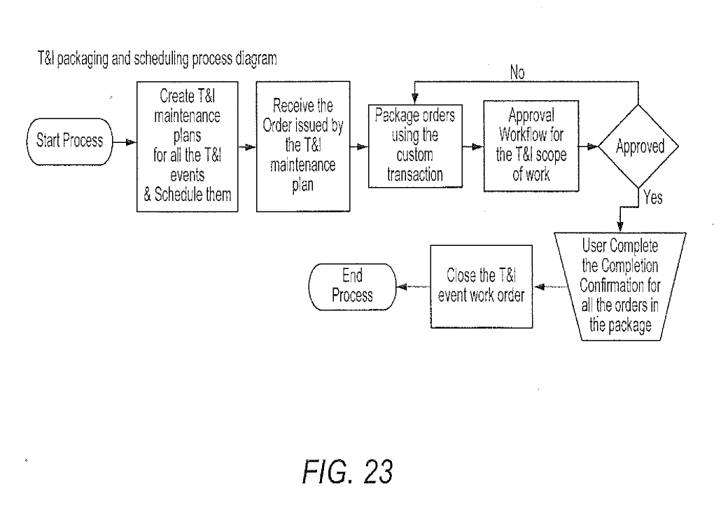

FIG. 23 is a flow diagram of a Testing and Inspection, Packaging and Scheduling Module. Such Module is responsible for maintaining a testing and inspection schedule and to package (group together) multiple testing and inspection tasks for different equipment in the same plant to be performed during the same testing and inspection event. The testing and inspection event schedule is stored in a table for each unit in the plant and a once-off maintenance plan is created for each event. A transaction can be used to easily create the testing and inspection scope of work.

As shown in FIG. 23, maintenance plans for all testing and inspection events are created and scheduled in the Testing and Inspection Module. Near scheduled times, the system packages orders using the custom transaction to create an event work order containing all of the work to be performed during the scheduled event.

The Module sends notification to an appropriate supervisor requesting approval of the proposed event work order (including the proposed workflow and scope of work). If approved, the work procedes using the remaining appropriate testing and maintenance Modules. Once all the work in an event work order has been completed, the work order is closed.

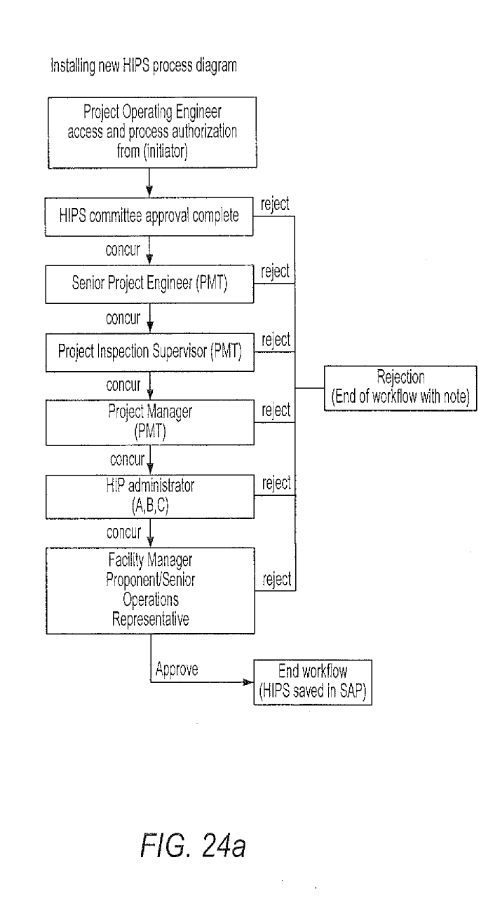

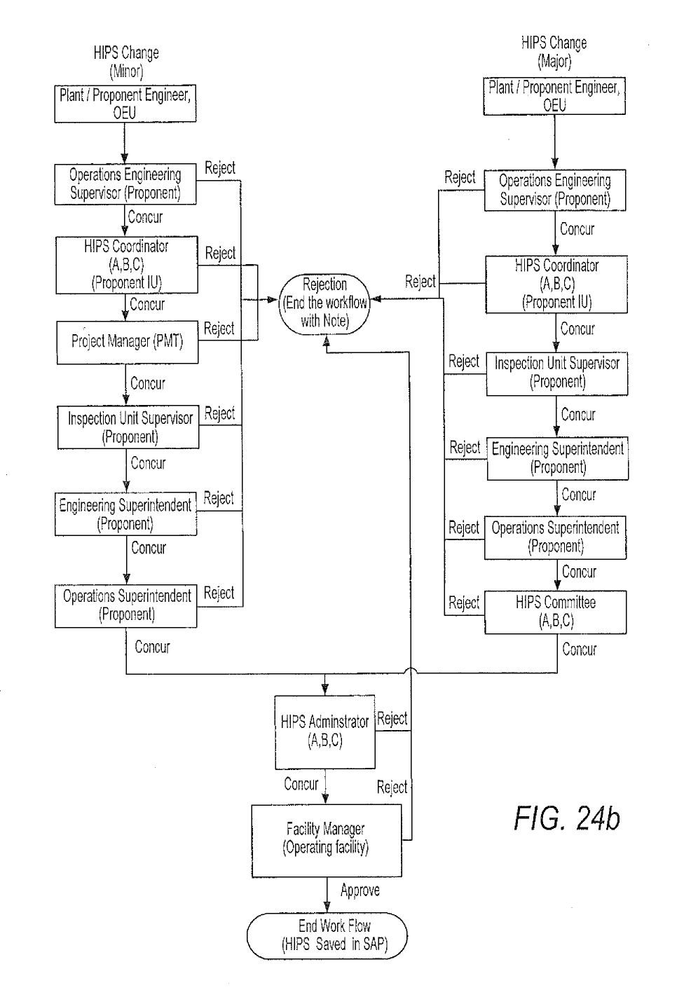

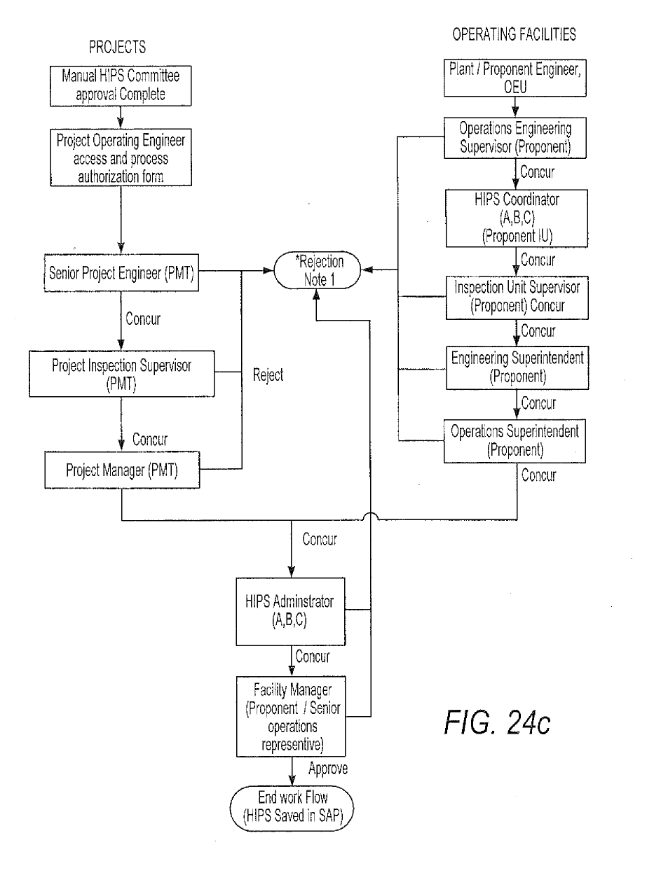

FIG. 24a is a flow diagram of a High Integrity Protection (“HIP”) System Module for the process of installing new HIP system.

FIG. 24b is a flow diagram of a HIP System Module for changing an existing HIP System.

FIG. 24c is a flow diagram of a HIP System Module for testing of an HIP System.

1. An inspection and maintenance system for an industrial plant or other facility comprising a computer having a processor, input/output equipment coupled to said processor for sending electronic information to, and receiving electronic information from, external personnel, notification equipment to generate and send notifications electronically to selected plant personnel; and a plurality of software modules communicating with said processor; wherein each said module is programmed to control a specific inspection or maintenance procedure for equipment in the plant which requires periodic inspection and maintenance, including modules which are programmed to perform the following functions:
store and track the next upcoming inspection date for each piece of such equipment;
cause the notification equipment to send electronic notification to a preselected inspector when an inspection date for a piece of equipment is coming due;
receive electronically information from such inspector reporting on such inspection and determine, store, and track a new next upcoming inspection date for such equipment piece;
receive electronically from such inspector information indicating that maintenance is required on such equipment piece and, in response, cause the notification equipment to send notification to a preselected maintenance personnel that maintenance work is required;
receive electronically from such maintenance personnel an acknowledgement that maintenance is required, and provide a Worksheet to specify the flow of maintenance work; and
communicate interactively with such maintenance personnel during the maintenance work until receiving confirmation that the maintenance work has been completed.

2. The system of claim 1, wherein at least two modules are programmed to work together interactively during at least certain circumstances during maintenance work.
